(19) United States
(12) Patent Application Publication
(10) Pub. No.: US 2022/0050938 A1
(43) Pub. Date: Feb. 17, 2022

(54) PREDICTIVE MODELING FOR CLOUD CAPACITY MANAGEMENT

(71) Applicant: Microsoft Technology Licensing, LLC, Redmond, WA (US)

(72) Inventors: Arjun Mukherjee, Bellevue, WA (US); Wuqin Lin, Redmond, WA (US); Banafsheh Samareh Abolhasani, Seattle, WA (US)

(21) Appl. No.: 16/991,562

(22) Filed: Aug. 12, 2020

(51) Int. Cl. G06F 30/20; H04L 29/08

(52) U.S. Cl. CPC G06F 30/20; G06F 2111/04; H04L 67/18; H04L 67/10

(57) ABSTRACT

In non-limiting examples of the present disclosure, systems, methods and devices for forecasting cloud service capacity and demand are presented. A cloud capacity forecast comprising a plurality of projections for a future timeframe may be generated via application of a predictive simulation model to one or more cloud service supply variables. A cloud demand forecast comprising a plurality of projections for the future timeframe may be generated via application of a predictive simulation model to a plurality of cloud service demand variables. A determination may be made as to a number and/or percentage of the projections for which the cloud capacity exceeds the cloud demand A confidence score that cloud service demand can be met may be calculated. In some examples, one or more prophylactic actions may be automatically performed if the confidence score is below a threshold value.

### BACKGROUND

Demands on cloud services fluctuate regularly, as do the amount of resources (e.g., virtual cores, memory) that are available and operational in any given geographic service region of a cloud service. Because of this fluctuation it is difficult to predict whether there will be enough computing resource capacity to handle workload demands that are ever changing. When customers request additional bandwidth for future dates it would be useful to be able to determine whether the current and future computing resources will be able to accommodate those computing workloads. Similarly, it would be useful to know whether it appears unlikely that high priority customer workloads are going to be able to be accommodated in a particular service region so that prophylactic actions may be taken.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for forecasting cloud service capacity and demand A cloud forecast service may receive a request to determine whether there will be enough cloud capacity in a cloud service region to meet cloud demand in the service region for a future timeframe (e.g., for the next month, for the next four months). A cloud capacity forecast comprising a plurality of projections for a future timeframe may be generated via application of a predictive simulation model to one or more cloud service supply variables. The cloud service supply variables may comprise current server/virtual machine install base in the service region, estimated time of arrival for future incoming server clusters to the service region, and existing cluster actual live dates for the service region. A cloud demand forecast comprising a plurality of projections for the future timeframe may be generated via application of a predictive simulation model to a plurality of cloud service demand variables. The plurality of cloud service demand variables may comprise historical cloud use data and cloud subscription data for one or more consumers (e.g., customers) hosted by the service region. In some examples, forelog and backlog service requests may be added to a cloud demand forecast. A determination may be made, based on the cloud capacity and cloud demand forecasts, as to a number and percentage of the projections for which the cloud capacity exceeds the cloud demand during the forecast timeframe. A confidence score corresponding to a likelihood that cloud service demand can be met may be calculated. In some examples, one or more prophylactic actions may be automatically performed if the confidence score is below a threshold value.

### BRIEF DESCRIPTION OF THE DRAWINGS

Non-limiting and non-exhaustive examples are described with reference to the following figures:

FIG. 1 is a schematic diagram illustrating an example distributed computing environment for forecasting cloud service capacity and demand

FIG. 2 illustrates a simplified computing environment for forecasting high priority cloud service consumer use for a region over a temporal horizon.

FIG. 3A illustrates a simplified computing environment for forecasting cloud service demand for a cloud service over a temporal horizon.

FIG. 3B illustrates another simplified computing environment for forecasting cloud service demand for a cloud computing service over a temporal horizon.

FIG. 4 illustrates a simplified computing environment for forecasting cloud service capacity for a cloud service over a temporal horizon.

FIG. 5 illustrates a graph depicting a gap distribution for a future timeframe.

FIG. 6 is an exemplary method for forecasting cloud service capacity and demand

FIG. 7 is another exemplary method for forecasting cloud service capacity and demand

FIGS. 8 and 9 are simplified diagrams of a mobile computing device with which aspects of the disclosure may be practiced.

FIG. 10 is a block diagram illustrating example physical components of a computing device with which aspects of the disclosure may be practiced.

FIG. 11 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for forecasting cloud service capacity and demand A cloud forecast service may determine whether a cloud computing service will be able to meet cloud service demands in one or more service regions based on cloud service capacity in those service regions. The cloud service computing demand and capacity may be calculated in cloud computing units (e.g., virtual cores). The demand requirements may differ based on a service level associated with a cloud consumer type. For example, high priority cloud consumers (e.g., large customers, first responder entities) may need to have their demand requirements satisfied in a desired service region a first threshold percentage of the time (e.g. 99.9% of the time, 99.5% of the time), and lower priority cloud consumers may need to have their demand requirements satisfied in a desired service region a second threshold percentage of time (e.g., 97.0% of the time, 95.0% of the time) that is less than the first threshold percentage.

The cloud forecast service may receive a request to generate a capacity-demand forecast for a service region over a future temporal horizon. The future temporal horizon may differ based on the request. For example, the future temporal horizon may comprise a week, a month, two months, three months, four months, or longer. In generating a capacity-demand forecast, the cloud forecast service may generate a cloud demand forecast for the service region and a cloud capacity forecast for the service region. The cloud demand forecast may be generated via application of a predictive simulation model to a plurality of cloud service demand variables associated with each cloud consumer that is hosted by the service region. The cloud capacity forecast may be generated via application of a predictive simulation model to a plurality of cloud service supply variables associated with the cloud service and the service region. In some examples, the predictive simulation models used to generate the cloud demand forecast and the cloud capacity forecast may be the same or different models. In some examples, the predictive simulation models may comprise a Monte Carlo model, which is a statistical technique that is used to predict the probability of complex events by compiling many different outcomes from predetermined input variables.

The plurality of cloud service demand variables may comprise historical usage data for each cloud consumer that is hosted by the service region. In some examples, the plurality of cloud service demand variables may include forelogs and backlogs for cloud consumers that are hosted by the service region. In other examples, only forelogs and backlogs for high priority cloud consumers (e.g., cloud consumers with highest service levels associated with them) may be taken into account by the predictive simulation model. In still additional examples, in generating a demand forecast for a service region, the cloud forecast service may apply the predictive simulation model to the historical usage data for each cloud consumer hosted by the service region and add the forelog and backlog data to the resulting forecast that is generated.

The output of the predictive simulation model to the cloud service demand variables is thus a plurality of cloud demand projections for a service region from some future point in time to a temporal horizon. Each of the plurality of projections may include an hourly or daily number of virtual cores that are projected to be used by customers in the timeframe corresponding to the temporal horizon. For example, if the timeframe is four months (e.g., July 1 to November 1), each output projection from the predictive simulation model may have a determined number of virtual cores for each day (or hour) in the four months from July 1 to November 1 that are estimated to be used by cloud consumers in the service region.

The plurality of cloud service supply variables may comprise a current virtual core install base (e.g., available capacity, number of available server clusters), estimated live dates for future incoming server clusters, and existing cluster actual live dates. The output of the predictive simulation model to the supply variables is thus a plurality of cloud capacity projections for a service region from some future point in time to a temporal horizon. Each of the plurality of projections may include an hourly or daily number of virtual cores that are expected to be operational in the timeframe corresponding to the future point in time and the temporal horizon. For example, if the timeframe is four months (e.g., July 1 to November 1), each output projection from the predictive simulation model may have a determined number of virtual cores for each day (or hour) in the four months from July 1 to November 1 that are estimated to be operational in the service region.

Once the cloud capacity forecast and the cloud demand forecast have been generated, the cloud forecast service may determine a capacity excess distribution (“gap distribution”) for each day in a timeframe (e.g., from the future point in time to the temporal horizon). That is, determinations may be made as to the delta between a number of virtual cores that are estimated to be operational in a service region for each day in the timeframe (based on the demand forecast), and a number of virtual cores that are estimated to be used/needed to fulfill customer/subscription workload execution on each day in a service region for each day in the timeframe (based on the capacity forecast). In some examples, each day in the timeframe may have many different gap distributions determined for it based on the number of projections in each forecast. For example, for a first day in a timeframe, each projected virtual core demand value for that first day from the demand forecast may be subtracted from each projected virtual core capacity value for that same day.

A confidence score that cloud capacity will meet cloud demand for a service region may be determined by the cloud forecast service. The confidence score may be determined by calculating a percentage of the gap distributions from the demand and capacity projections that have positive values (e.g., excess capacity). If greater than a first threshold percentage (e.g., 99.9%, 99%) of projections have a positive capacity excess for a timeframe (e.g., from a future time to a temporal horizon), the cloud forecast service may determine that a service level for high priority cloud consumers in the service region will be met. If greater than a second threshold percentage (e.g., 90%, 95%) of projections, but less than the first threshold percentage, have a positive capacity excess for the timeframe, the cloud forecast service may determine that service level for high priority cloud consumers in the service region are unlikely to be met unless one or more prophylactic actions are taken. If less than the second threshold percentage of projections (e.g., less than 90% of the projections, less than 95% of the projections) have a positive capacity excess for the timeframe, the cloud forecast service may determine that the service level for high priority cloud consumers in the service region will not be met, regardless of whether prophylactic actions are taken by the cloud forecast service.

The systems, methods, and devices described herein provide technical advantages for managing computing workloads in cloud service regions. It is often difficult for cloud services to guarantee cloud computing units will be available to meet future demand requirements, even for high priority customers. This means that cloud services have to refuse new service requests from new and/or existing customers in a service region, add excess cloud computing resources (e.g., servers) that may not be used, or onboard new computing workloads to service regions that are not optimal for handling those workloads. The predictive simulation models described herein provide for accurate capacity and demand forecasting across diverse timeframes and cloud computing customers with different service needs. These forecasts allow cloud services to provide service level guarantees to high priority customers in addition to allowing cloud services to mitigate potential lack of cloud capacity through the performance of various prophylactic actions across cloud service regions.

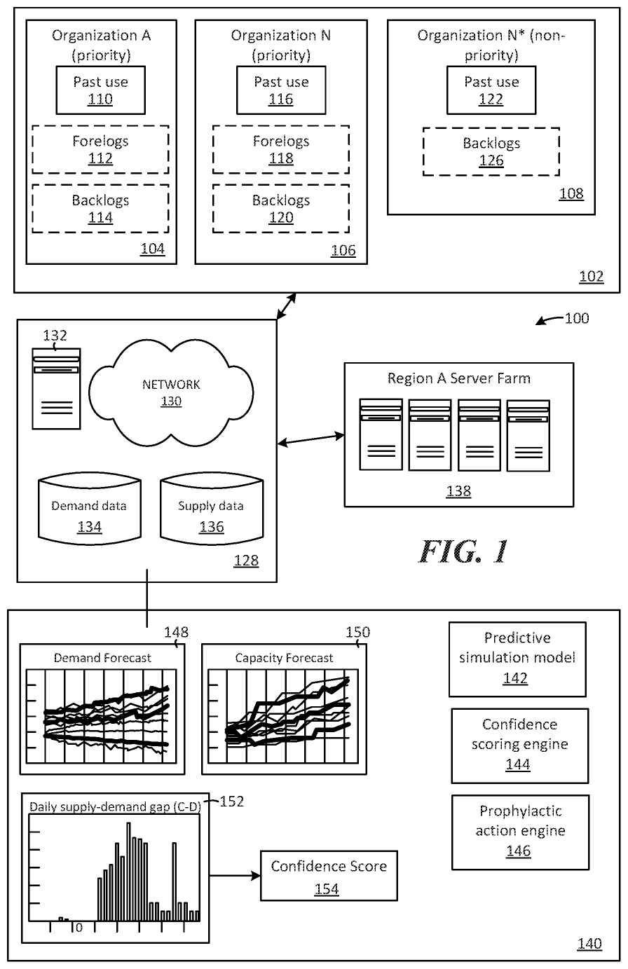

FIG. 1 is a schematic diagram illustrating an example distributed computing environment 100 for forecasting cloud service capacity and demand Distributed computing environment 100 includes cloud consumer sub-environment 102, network and processing sub-environment 128, region A server farm 138, and cloud service forecasting sub-environment 140.

Network and processing sub-environment 128 includes network 130, server computing device 132, demand data store 134, and supply data store 136. Any of the computing devices described herein may communicate with one another via a network, such as network 130. Server computing device 132 is exemplary of one or more computing devices that may execute a cloud forecast service. The cloud forecast service may perform operations associated with forecasting regional cloud service demand for a temporal horizon (e.g., hours, days, months, years in the future), forecasting regional cloud service supply for a temporal horizon (e.g., hours, days, months, years in the future), determining whether service level guarantees for cloud service consumers (e.g., organizations, individual users, customers) may be met based on past cloud service usage and current forelog and backlog requests, and/or performing one or more prophylactic follow-up actions if a determination is made that a service level guarantee is unlikely to be met by the cloud service provider. Although the cloud forecast service is primarily described herein as operating on one or more servers (e.g., being cloud based), the cloud forecast service may additionally or alternatively be executed all or in part on one or more local computing devices.

Demand data store 134 and supply data store 136 may be in separate data stores as illustrated in network and processing sub-environment 128, or they may be comprised in a single data store. Demand data store 134 may comprise historical cloud consumer subscription data for one or more cloud consumers and one or more regions of a cloud service. The historical cloud consumer subscription data may include a number of virtual cores that were utilized or requested by each cloud consumer in one or more regions of a cloud service in association with the times, hours, days or dates that they were utilized and/or requested. The historical cloud consumer subscription data may additionally include the type and/or specifications of virtual cores that were requested. Demand data store 134 may additionally include forelog and backlog data for one or more cloud consumers and one or more regions of a cloud service. The forelog data may comprise historical forelog data (e.g., times, days or dates that additional virtual cores were requested and/or how far out the forelog requests were for) and/or current forelog data (e.g., number of future virtual core requests and dates when those requests are to be filled). The backlog data may comprise historical backlog data (e.g., times, days or dates and numbers of virtual cores that were requested, how long it took to fill backlogs for those requests).

Supply data store 136 may comprise install base data (e.g., number and/or type of virtual cores that are available for filling new cloud service requests in a region of a cloud service), future incoming cluster data (e.g., type of new servers and virtual cores that have been ordered for a region of a cloud service, brand of new servers and virtual cores that have been ordered for a region of a cloud service, specifications of new servers and virtual cores that have been ordered for a region of a cloud service, historical data describing how long it takes to fill incoming server clusters from server providers), and/or existing cluster actual live date data (e.g., server cluster ID, region, resource type, SKU generation, actual live date daily feed).

Region A server farm 138 includes a plurality of server clusters that are included in a service region (service region A) of a cloud service. The server clusters may be the same type or different types and have the same or different virtual core types and specifications. For example, a cloud service may have a plurality of regions (e.g., US-Northeast, US-South,

US-Central, Europe-South, Europe-West) that host cloud consumer workloads, and region A server farm 138 may correspond to one of those regions.

Cloud consumer sub-environment 102 includes a plurality of organizations that host their data and/or one or more applications by the cloud service, and specifically, in region A server farm 138. The cloud forecast service maintains historical cloud use data and outstanding cloud demand data for each of organization A 104, organization N 106 and organization N* 108. Thus, while past cloud use data 110, past cloud use data 116 and past cloud use data 122 are described for ease of illustration as being included in corresponding organizations, it should be understood that the data is maintained by the cloud forecast service. Similarly, while forelogs data 112, forelogs data 118, backlogs data 114, backlogs data 120 and backlogs data 126 are described as being included in corresponding organizations, it should be understood that the data is maintained by the cloud forecast service.

Cloud consumer sub-environment 102 includes organization A 104, which is a high priority customer of the cloud service. Organization A 104 includes past cloud use data 110 (e.g., historical data) for the cloud service, including past cloud use data for region A server farm 138, forelogs data 112 (which may include current and historical forelog data for organization A 104 and the cloud service), and backlogs data 114 (which may include current and historical backlog data for organization A 104 and the cloud service).

Cloud consumer sub-environment 102 further includes organization N 106, which is a high priority customer of the cloud service. Organization N 106 includes past cloud use data 116 (e.g., historical data) for the cloud service, including past cloud use data for region A server farm 138, forelogs data 118 (which may include current and historical forelog data for organization N 106 and the cloud service), and backlogs data 120 (which may include current and historical backlog data for organization N 106 and the cloud service).

Cloud consumer sub-environment 102 further includes organization N* 108, which is a non-priority customer of the cloud service. Organization N* includes past cloud use data 122 (e.g., historical data) for the cloud service, including past cloud use data for region A server farm 138, and backlogs data 126 (which may include current and historical backlog data for organization N* 108 and the cloud service). In some examples, the cloud service may only maintain historical forelog and backlog data for high priority customers (e.g., organization A 104, organization 106). In other examples, the cloud service may maintain backlog data for high priority customers and non-priority customers.

A cloud service consumer (e.g., organization A 104, organization N 106, organization N* 108) may provide the cloud service with a request for a plurality of virtual cores that are to be ready to handle one or more computing loads at a date in the future. A determination may be made as to a type of service level that is associated with the cloud service consumer. For example, a first service level may provide that customers associated with that first level will have their computing loads executed on virtual cores in requested regions 99.9% of the time. For example, 99.9% of the time those customers at the first service level will have their computing workloads handled by virtual cores at a requested region, and only 0.1% of those workloads may be offloaded to servers/virtual cores in other service regions. A second service level may provide that customers associated with that second level are guaranteed to have the customers' computing workloads executed on requested regions 99.0% of the time (e.g., 1% of the time the second level customers may have their computing loads executed in other service regions, and/or 1% of the requested virtual cores in the requested region may not be available to execute the second level customers' workloads). A third service level may provide that customers associated with that third level are guaranteed to have the customers' computing workloads executed on requested regions 90.0% of the time (e.g., 10% of the time the third level customers may have their computing loads executed in other service regions, and/or 10% of the requested virtual cores in the requested region may not be available to execute the third level customers' workloads).

In some examples, the cloud forecast service may make a determination based on an explicit forelog request from a customer/consumer as to whether a requested service region can meet the service level for that customer (e.g., guarantee virtual core capacity to meet requested demand) The determination may include a temporal horizon corresponding to a duration of time from when the forelog is to be filled (e.g., forelog target date) to a horizon date (e.g., one month after the forelog target date, three months after the forelog target date, five months after the forelog target date), which the service level is likely to be able to be met (e.g., to within 99% assurance, to within 99.9% assurance, to within 95% assurance). In additional examples, the cloud forecast service may make a determination as to whether all future requests for additional service and all current cloud subscriptions and their corresponding service levels are likely to be met in a service region from an input target date in the future until a horizon date.

The cloud forecast service may generate a cloud demand forecast via application of predictive simulation model 142 to a plurality of cloud service demand variables, as illustrated by cloud demand forecast 148. Predictive simulation model 142 may comprise a Monte Carlo model. A cloud demand forecast may comprise a plurality of cloud service demand projections for a region of the cloud service (e.g., projections estimating how many virtual cores are needed to execute all of the computing workloads from customers of a service region). In generating a cloud demand forecast, the cloud forecast service may apply the predictive simulation model 142 to a plurality of cloud service demand variables. The plurality of cloud service demand variables may comprise historical usage data and/or cloud subscription data for each customer that is hosted by the service region (e.g., region A server farm 138), and forelogs and backlogs for customers that are hosted by the service region. In some examples, only forelogs and/or backlogs for high priority customers may be taken into account by predictive simulation model 142 (e.g., only current forelogs and backlogs for customers that are associated with a highest service level). The output of predictive simulation model 142 is thus a plurality of cloud demand projections for a service region from some future point in time to a temporal horizon. Each of the plurality of projections may include an hourly or daily number of virtual cores that are projected to be used by customers in the timeframe corresponding to the future point in time and the temporal horizon. For example, if the timeframe is four months (e.g., July 1 to November 1), each output projection from the predictive simulation model 142 may have a determined number of virtual cores for each day (or hour) in the four months from July 1 to November 1 that are estimated to be used by customers in the service region.

The cloud forecast service may generate a cloud capacity forecast via application of the predictive simulation model 142 to a plurality of cloud service supply variables, as illustrated by cloud capacity forecast 150. A cloud capacity forecast may comprise a plurality of cloud service capacity projections for a region of the cloud service. In generating a cloud capacity forecast, the cloud forecast service may apply predictive simulation model 142 to a plurality of cloud service supply variables. The plurality of cloud service supply variables may comprise a current virtual core install base (e.g., available capacity, number of available server clusters), estimated live dates for future incoming server clusters, and/or existing cluster actual live dates. The output of predictive simulation model 142 to the supply variables is thus a plurality of cloud capacity projections for a service region from some future point in time to a temporal horizon. Each of the plurality of projections may include an hourly or daily number of virtual cores that are expected to be operational in the timeframe corresponding to the future point in time and the temporal horizon. For example, if the timeframe is four months (e.g., July 1 to November 1), each output projection from the predictive simulation model 142 may have a determined number of virtual cores for each day (or hour) in the four months from July 1 to November 1 that are estimated to be operational in the service region.

Once the cloud capacity forecast and the cloud demand forecast have been generated, the cloud forecast service may determine a gap distribution for each day in a timeframe (e.g., from the future point in time to the temporal horizon). That is, determinations may be made as to the delta between a number of virtual cores that are estimated to be operational in a service region for each day in the timeframe (based on the capacity forecast), and a number of virtual cores that are estimated to be used/needed to fulfill customer/subscription workload execution on each day in a service region for each day in the timeframe (based on the demand forecast). In some examples, each day in the timeframe may have many different gap distributions determined for it. For example, for a first day in a timeframe, each projected virtual core demand value for that first day from the demand forecast may be subtracted from each projected virtual core capacity value for that same day. In other examples, only projected virtual cores for the demand forecast at a specific P level (e.g., P99, P90) may be subtracted from each projection in the capacity forecast and/or from specific P level (e.g., P10, P50) of the capacity forecast.

An exemplary gap distribution for a day in a timeframe is illustrated by daily supply-demand gap forecast 152. Daily supply-demand gap forecast 152 in this example illustrates that there is a very small percentage of projections where the demand on the service region for that day is expected to exceed the supply (capacity). That is, the Y axis of forecast 152 corresponds to a number of projections for the represented day in the timeframe, and the X axis of forecast 152 corresponds to the gap distribution that was determined for each projection. Thus, there are many projections that have positive/excess capacity for the day (the bars to the right of zero on the X axis), and there are very few projections that have negative capacity (e.g., excess demand) for the day (the bars to the left of zero on the X axis).

Once the gap distribution for each day in a timeframe is determined, the cloud forecast service may determine a confidence score corresponding to a likelihood that service levels for customers can be met. The confidence score may be determined via processing of the daily supply demand gap data by confidence scoring engine 144. The confidence score may be calculated by determining the percentage of positive capacity gaps projected during a timeframe. For example, for high priority customers, there may be a service level that guarantees that there will be capacity in a region to meet demand 99% of the time. As such, if 99.5% of the gap distribution projections for a timeframe (e.g., July 1 to November 1) and a region are positive, which could encompass thousands or millions of projections, the confidence score would be 99.5, and the service level for the high priority customers would be determined to be met for that service region and that timeframe. The confidence score for a timeframe is illustrated by confidence score element 154.

In some examples, for high priority customers, with the highest service levels associated with them, a confidence score of 99% or above means that a cloud service can meet the high priority customer service demand (e.g., fulfill the service level guarantee) for a given timeframe and region; a confidence score of between 95% and 99% means that that the cloud service may perform one or more prophylactic actions via prophylactic action engine 146 to mitigate potential lack of supply during a given timeframe and region, and a confidence score of less than 95% means that the cloud service will not be able to meet service demand during a given timeframe and region. Prophylactic action engine 146 may perform actions such as moving workloads for lower priority customers (customers with lower service levels associated with them) to different service regions, ordering additional server clusters for a service region, or putting a pause or slowing down the fulfillment of backlogs or forelogs for lower priority customers.

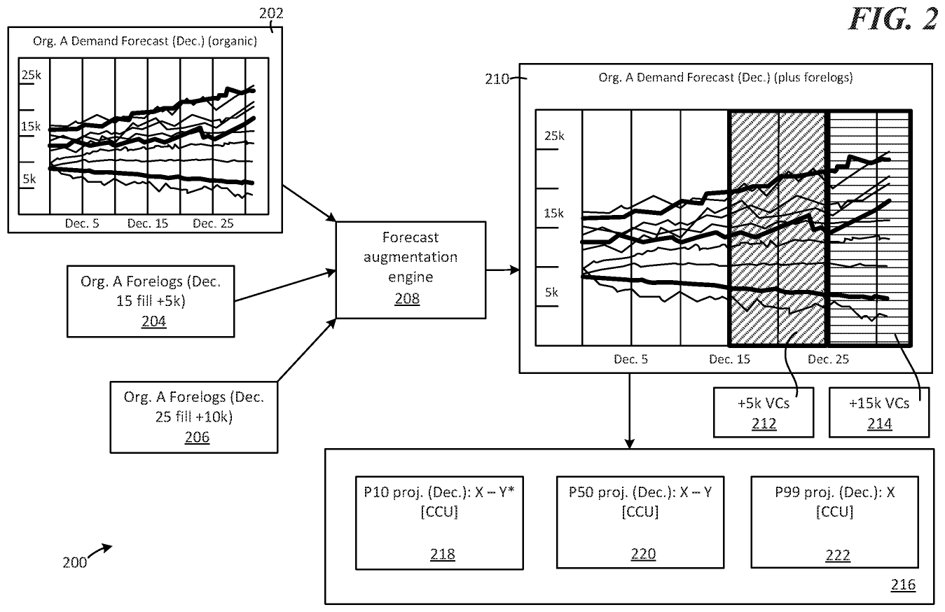

FIG. 2 illustrates a simplified computing environment 200 for forecasting high priority cloud service consumer use for a region over a temporal horizon. The cloud forecast service may generate individualized cloud service demand/use forecasts for high priority customers. In some examples, the individualized forecasts may be regional (e.g., for a single service region of the cloud service). In other examples, the individualized forecasts may be comprehensive for the cloud service (e.g., all regions of the cloud service).

In this example, the cloud forecast service is generating a demand forecast for organization A for a future timeframe (e.g., the month of December). The cloud forecast service may apply a predictive simulation model (e.g., a Monte Carlo model) to historical demand variables for organization A for the region that it is generating the forecast for. In some examples, the historical demand variables for the organization may include hourly and/or daily historical data (e.g., 12 months of data, 18 months of data) for the organization that includes a number of virtual cores used and/or types of virtual machines/virtual cores used. Those historical demand variables and the date range of the forecast (in this case December 1 to December 31) are processed by the predictive simulation model, and the output of the model is illustrated as organization A organic demand forecast 202, where the “organic” designation simply denotes that the forecast is based on historical data and does not include current forelogs or backlogs.

Organic demand forecast 202 includes a plurality of demand projections for the month of December, with the top bold line illustrating the P99 demand projection, the middle bold line illustrating the P50 demand projection, and the lower bold line illustrating the P10 demand projection. The X axis of demand forecast 202 provides the dates in the forecast (December 1 to December 31), and the Y axis provides the number of cloud computing units (e.g., virtual cores, Azure Compute Units (ACUs)) needed to meet demand for organization A in the service region.

In this example, because the customer (organization A) has a high service level associated with it or because the customer has existing forelogs, the cloud forecast service may augment demand forecast 202 with forelogs that are to be filled during the timeframe of the forecast. Specifically, in this example, the customer has first forelog request 204 and second forelog request 206. First forelog request 204 is to be fulfilled by the cloud service in the service region corresponding to the forecast on December 15, and the order is for 5,000 cloud computing units (e.g., virtual cores). Second forelog request 206 is to be fulfilled by the cloud service in the region corresponding to the forecast on December 25, and the order is for 10,000 cloud computing units.

Forecast augmentation engine 208 may process the number of cloud computing units from first forelog request 204 and add them to organic demand forecast 202, as indicated by first augmentation frame 212 on augmented demand forecast 210. Specifically, there are an additional 5,000 cloud computing units that have been added on December 15. Although the additional 5,000 cloud computing units are illustrated by the diagonal pattern on augmented demand forecast 210, the additional cloud computing units may be illustrated by moving each of the projections on that graph up in the Y axis to a point corresponding to 5,000 cloud computing units from the base projections of demand of organic demand forecast 202.

Forecast augmentation 208 may process the number of cloud computing units from second forelog request 206 and add them to organic demand forecast 202, as indicated by second augmentation frame 214 on augmented demand forecast 210. That is, because first forelog request 204 was for 5,000 cloud computing units and second forelog request 206 was for 10,000 cloud computing units, second augmentation frame 214 illustrates that there are an additional 15,000 cloud computing units added on December 25 from the base number of cloud computing units on December 25 depicted by organic demand forecast 202. Although the additional 15,000 cloud computing units are illustrated by the horizontal pattern on augmented demand forecast 210, the additional cloud computing units may be illustrated by moving each of the projections on that graph up in the Y axis to a point corresponding to 15,000 cloud computing units from the base projections of demand of organic demand forecast 202.

P level demand projections for augmented demand forecast 210 are illustrated by the bold lines in augmented demand forecast 210, as well as in P level projections 216. Specifically, the top bold line illustrates the P99 demand projection in addition to P99 projection 222 indicating that the P99 demand projection has X cloud computing units for the organization for December. The middle bold line illustrates the P50 demand projection in addition to P50 projection 220 indicating that the P50 demand projection has X minus Y cloud computing units for the organization for December. The lower bold line illustrates the P10 demand projection in addition to P10 projection 218 indicating the P10 demand projection has X minus Y* cloud computing units for the organization for December.

Although FIG. 2 illustrates the augmenting of a demand forecast with pending forelogs, the cloud forecast service may additionally or alternatively augment a demand forecast with pending backlogs. In some examples, the cloud forecast service may process historical backlog fill data for a customer (e.g., how long it takes to fill backlogs for the customer in the past) with the predictive simulation model as additional variables to determine additional projections for a demand forecast for the customer. In other examples, the cloud forecast service may determine a most likely fulfillment date for pending backlogs and augment the forecast with the backlog numbers on that fulfillment date.

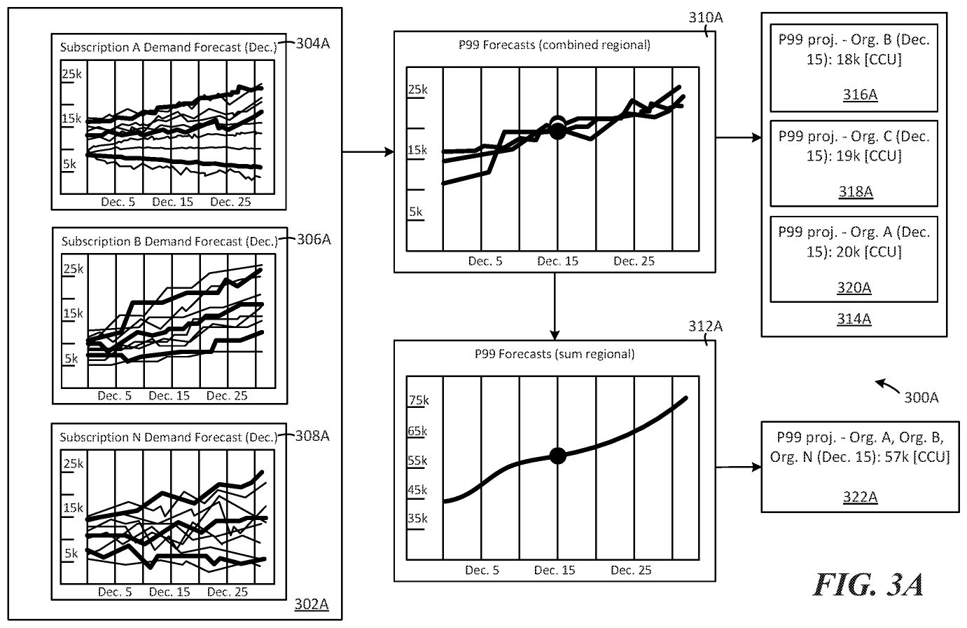

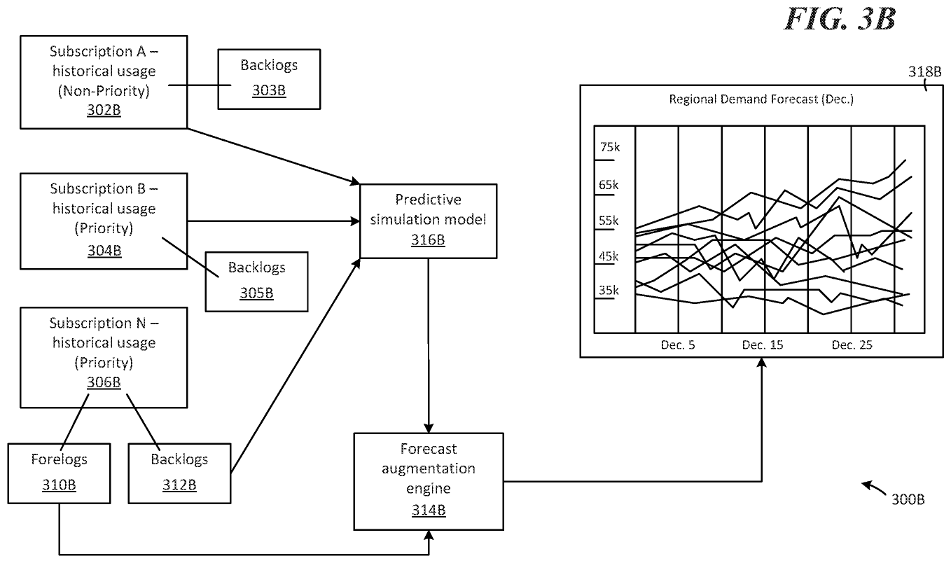

FIG. 3 illustrates a simplified computing environment 300 for forecasting cloud service demand for a cloud service over a temporal horizon. That is, computing environment 300 illustrates the generation and display of a demand forecast for an entire service region (e.g., Northeast US, Southwest US, etc.) from a future start date (e.g., December 1) to a future horizon date (e.g., December 30). Although the regional demand forecast is illustrated in FIG. 3 as corresponding to a one-month timeframe, it should be understood that regional demand forecasts may be generated for shorter or longer timeframes.

Computing environment 300 includes subscription forecasts 302, overlay forecast 310, summed subscription forecast 312, P level projections 314, and combined P99 forecast element 322.

Each customer of a cloud service may have one or more cloud subscriptions for a region of the cloud service. A cloud subscription may comprise an order and implementation of that order for a specific number of virtual cores of a specific type (e.g., 5000 virtual cores of the DSv2-series, 1000 virtual cores of the Dv2-series). The cloud forecast service may apply a predictive simulation model (e.g., a Monte Carlo model) to historical demand variables for each subscription for each customer served by the service region that it is generating a comprehensive demand forecast for. The historical demand variables for a subscription may include hourly and/or daily historical data (e.g., 12 months of data, 18 months of data) for each subscription that includes a number of virtual cores in the subscription and/or types of virtual machines/virtual cores in the subscription. Those historical demand variables and the date range of the forecast (in this case December 1 to December 31) are processed by the predictive simulation model for each of the subscriptions for the region. In this example, the subscriptions served by the service region are subscription A, subscription B, and subscription N. The output of the model for subscription A is illustrated as subscription A demand forecast 304. The output of the model for subscription B is illustrated as subscription B demand forecast 306. The output of the model for subscription N is illustrated as subscription N demand forecast 308. The subscription demand forecasts of FIG. 3 do not take into account existing forelog or backlog data for those subscriptions/customers. However, if there are existing forelogs or backlogs for those subscriptions/customers for the service region, the subscription forecasts may be augmented with those forelogs or backlogs.

Each of subscription forecasts 302 has P99, P50 and P10 projections bolded therein. In this example, the cloud forecast service generates overlay forecast 310, which is comprised of each of the P99 projections for the service region (e.g., the P99 projection for subscription A demand forecast 304, the P99 projection for subscription B demand forecast 306, and the P99 projection for subscription N demand forecast 308). The demand projection for each P99 projection is indicated by the circular marks/datapoints on that date on overlay forecast 310.

P level projections 314 includes first P99 projection 316 from subscription A demand forecast 304, which indicates that the P99 projection for December 15 (for subscription A) is 18,000 cloud computing units (e.g., virtual cores). P level projections 314 also includes second P99 projection 318 from subscription B demand forecast 306, which indicates that the P99 projection for December 15 (for subscription B) is 19,000 cloud computing units. P level projections 314 further includes third P99 projection 320 from subscription N demand forecast 308, which indicates that the P99 projection for December 15 (for subscription N) is 20,000 cloud computing units.

The cloud forecast service also generates summed subscription forecast 312, which provides a sum demand value from each of the P99 projections for the subscriptions in the region for the forecasted horizon. For example, as illustrated by combined P99 projection 322, the P99 forecast for each of the subscriptions in the service region for December 15 is projected to require 57,000 cloud computing units (e.g., virtual cores).

In some examples, a P level demand forecast for a region may be utilized by the cloud forecast service to determine a likelihood that a cloud service can meet demand for a service region and its customers. For example, the cloud forecast service may find the gap distribution between the P99 level demand forecast for a service region and the P10 or P1 level capacity forecast for the service region. A determination may then be made based on the gap distribution as to a likelihood that that the cloud service can meet service level demands for the service region. In other examples, in determining confidence scores for whether demand can be met for a service region over a temporal horizon, the cloud forecast service may calculate the gap distribution between each capacity projection (for each temporal datapoint in the timeframe) and each corresponding summed subscription demand projection (for each corresponding temporal datapoint in the timeframe). For example, if there are 10,000 capacity projections for December 15 for a service region, and there are 10,000 demand projections for each subscription on December 15, the delta between the sum of each of the demand subscriptions for December 15 and each of the 10,000 capacity projections for December 15 may be determined. A confidence score for meeting demand on December 15 may correspond to the percentage of gap distributions that were determined to be positive (e.g., capacity greater than demand)

FIG. 3B illustrates another simplified computing environment 300B for forecasting cloud service demand for a cloud computing service over a temporal horizon. Specifically, computing environment 300B illustrates the forecasting of demand data for a service region for an upcoming month (December). Computing environment 300B includes subscription A data 302B, which includes historical cloud usage data for the region for a non-priority customer of the cloud service (e.g., a customer that does not have a highest service level associated with it), as well as backlogs 303B. Computing environment 300B further includes subscription B data 304B, which includes historical cloud usage data for the region for a priority customer of the cloud service (e.g., a customer that has a highest service level associated with it), as well as backlogs 305B. The subscription/customer associated with subscription B data 304B does not have any current forelogs that are to be filled in the upcoming month (December) that the forecast is being generated for. Computing environment 300B further includes subscription N data 306B, which includes historical cloud usage data for the region for a priority customer of the cloud service. The subscription/customer associated with subscription N data 306B has forelogs 310B and backlogs 312B that are to be filled in the region in the upcoming month (December) that the forecast is being generated for. Computing environment 300B further includes predictive simulation model 316B, forecast augmentation engine 314B, and regional demand forecast 318B.

In examples, in generating a service region demand forecast, the cloud forecast service may combine historical use data (including backlogs) for each subscription in the region, while excluding forelogs from priority customers that are to be filled in the date range corresponding to the forecast. A predictive simulation model may then be applied to the historical use data for each of the subscriptions (excluding the forelog data for the priority customers). The service region demand forecast may then augment the output of the predictive simulation model with the forelog data for the timeframe for the priority customers. Thus, in this example, predictive simulation model 316B (e.g., a Monte Carlo model) may be applied to subscription A data 302B (including backlogs 303B), subscription B data 304B (including backlogs 305B), and/or backlogs 312B. The output from predictive simulation model 316B may then be augmented with forelogs from priority customers that are to be filled during the timeframe covered by the forecast. That is, forecast augmentation engine 314B may receive the output/forecast from predictive simulation model 316B and augment it with forelogs 310B, which are to be filled in upcoming month December corresponding to the forecast. The result of the processing performed by predictive simulation model 316B and forecast augmentation engine 314B is regional demand forecast 318B.

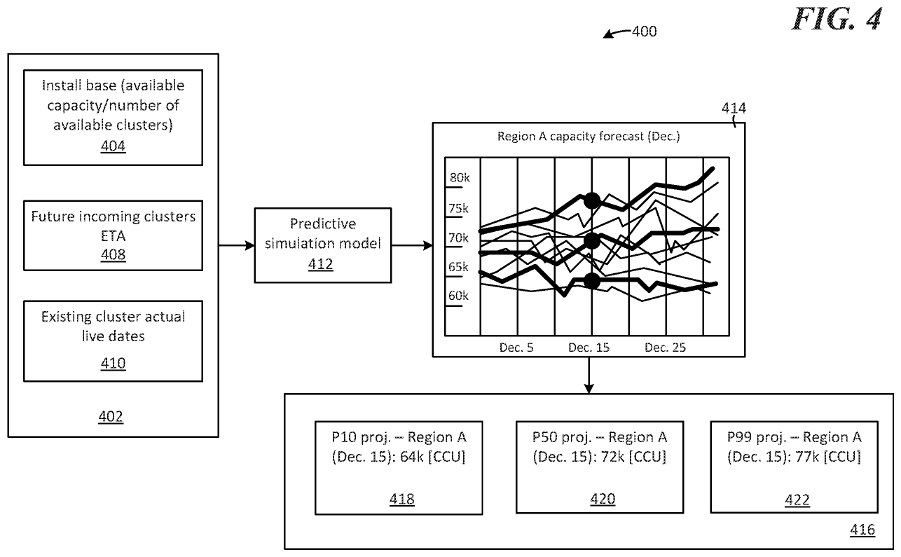

FIG. 4 illustrates a simplified computing environment 400 for forecasting cloud service capacity for a cloud service over a temporal horizon. Computing environment 400 includes cloud service supply variables 402, predictive simulation model 412, service region forecast 414, and P level projections 416.

Cloud service supply variables 402 include install base data 404 (e.g., number and/or type of virtual cores that are available for filling new cloud service requests in a region of a cloud service), future incoming cluster data 408 (e.g., type of new servers or virtual cores that have been ordered for a region of a cloud service, brand of new servers or virtual cores that have been ordered for a region of a cloud service, specifications of new servers or virtual cores that have been ordered for a region of a cloud service, historical data describing how long it takes to fill incoming server clusters from server providers), and existing cluster actual live date data 410 (e.g., server cluster ID, region, resource type, SKU generation, actual live date daily feed).

A future start date and horizon date (e.g., the timeframe of the forecast) may be input to predictive simulation model 412 (e.g., a Monte Carlo model) in addition to one or more of cloud service supply variables 402 to generate a plurality of projections as illustrated in region A capacity forecast 414. Capacity forecast 414 illustrates a plurality of projections for cloud computing capacity in region A for the upcoming month of December. Although capacity forecast 414 only includes projections for a single month, if a longer timeframe of the forecast is input into predictive simulation model 412, further reaching projections may generated.

P level projections 416 includes P10 projection 418, P50 projection 420, and P99 projection 422. Specifically, P10 projection indicates that the P10 projection in capacity forecast 414 for December 15 predicts 64,000 cloud computing units (e.g., virtual cores) will be available in region A on that date. P50 projection indicates that the P50 projection in capacity forecast 414 for December 15 predicts 72,000 cloud computing units will be available in region A on that date. P99 projection 422 for December 15 predicts 77,000 cloud computing units will be available in region A on that date.

In some examples, in determining whether a service level for a customer will be able to be met in in a service region (e.g., service region A) for a timeframe (e.g., in December), the cloud forecast service may calculate confidence scores by determining the gap distribution between each capacity projection for each day from a capacity forecast (e.g., capacity forecast 414), and each demand projection from an aggregate demand forecast for each corresponding day (e.g., the cloud computing unit sum for each corresponding day in each projection of subscription A demand forecast 304, subscription B demand forecast 306, and subscription N demand forecast 308). The percentage of positive distribution gaps (e.g., where projected capacity is greater than demand) may correspond to a confidence score for the timeframe of a forecast.

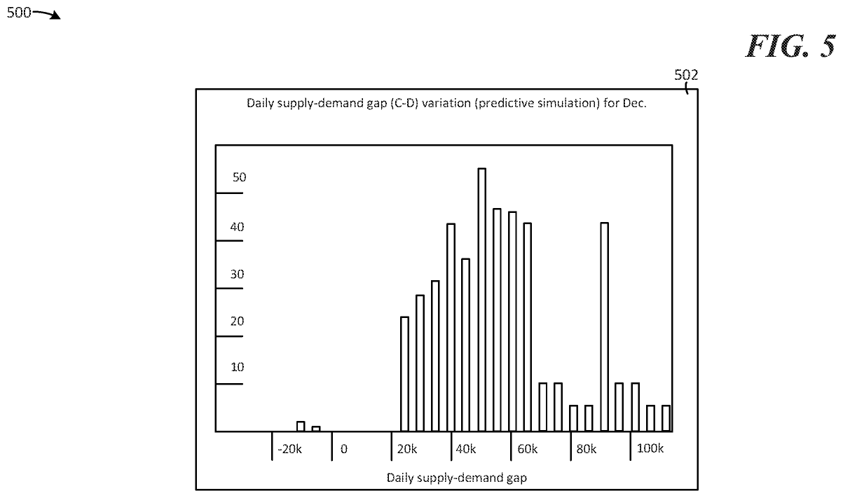

FIG. 5 illustrates a graph depicting a gap distribution for a future timeframe. Graph 502 illustrates the gap distribution for a plurality of projections from both capacity and demand estimates for the timeframe. The height of each bar corresponds to the frequency of the particular gap distribution where the bar is on the X-axis. That is, the Y-axis corresponds to frequency of occurrence (of particular gap distribution), and the X-axis corresponds to the gap distribution value (e.g., the delta between the projected capacity and demand)

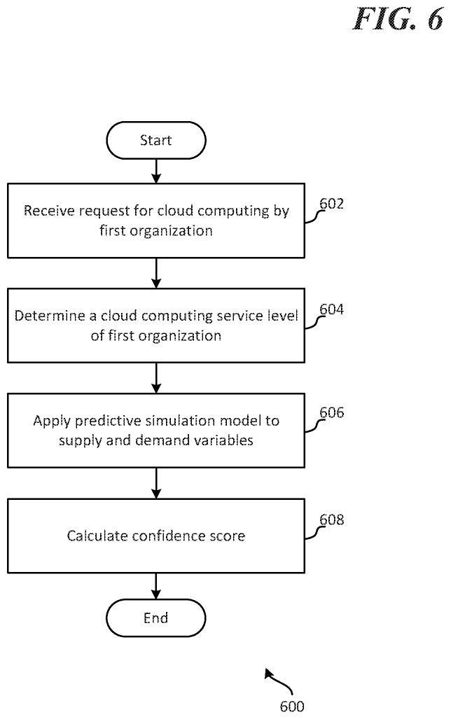

FIG. 6 is an exemplary method 600 for forecasting cloud service capacity and demand The method 600 begins at a start operation and flow moves to operation 602.

At operation 602 a forecasted request for cloud computing on a distributed cloud computing service is received from a first organization. The forecasted request may comprise a number of virtual cores needed to fulfill the forecasted request, a temporal constraint defining a date when the request is expected to be fulfilled, and a geographic region of the distributed cloud computing service where the cloud computing is expected to be fulfilled. For example, the forecasted request may comprise an order for X number of virtual cores of type A to be fulfilled by the distributed cloud computing service on date B in the future in geographic region C of the distributed cloud computing service. In some examples, the request may be for more than one type of virtual core.

From operation 602 flow continues to operation 604 where a cloud computing service level of the first organization is determined, wherein the cloud computing service level is associated with a first service level guarantee. That is, the cloud computing service may associate different service levels with different customers. A highest service level may guarantee that there will be cloud computing capacity in requested service regions to meet cloud demand for customers having that service level, to within a threshold confidence score level (e.g., 99.9%, 99.5%). A second highest service level may guarantee that there will be cloud computing capacity in requested service regions to meet cloud demand for customers having that service level, to within a threshold confidence score level (e.g., 90%, 95%). Other service levels and guarantees associated with those service levels may be included. For example, some service levels may not have a guarantee associated with them that their workloads will be hosted by any particular service region.

From operation 604 flow continues to operation 606 where a predictive simulation model is applied to a first plurality of cloud service demand variables for the first organization, a second plurality of cloud service demand variables for a second organization that is provided service by the geographic region of the distributed cloud computing service, and a cloud service supply variable for the geographic region of the distributed cloud computing service. The predictive simulation model may comprise a Monte Carlo model.

The first plurality of cloud service demand variables may comprise the number of virtual cores included in the request, virtual core usage history of the first organization for the geographic region of the distributed cloud computing service for a plurality of past days, and/or a number of virtual cores backlogged for the first organization for the geographic region of the distributed cloud computing service. The second plurality of cloud service demand variables may comprise virtual core usage history for the second organization for the geographic region of the distributed cloud computing service for a plurality of past days; a number of virtual cores backlogged for the second organization for the geographic region of the distributed cloud computing service, and/or a number of virtual cores forelogged for the second organization for the geographic region of the distributed cloud computing service. The cloud service supply variable for the geographic region of the distributed cloud computing service may comprise a number of virtual cores that are expected to be operational at the geographic region of the distributed cloud computing service on the date when the request is expected to be fulfilled.

A cloud service demand forecast for the geographic region and a plurality of days or months (e.g., a horizon) beginning at the date defined by the temporal constraint may be generated based on the application of the predictive simulation model to the first plurality of cloud service demand variables for the first organization and the second plurality of cloud service demand variables for the second organization. In some examples, the cloud service demand forecast may be generated based on application of the predictive simulation model to one or more additional variables or historical demand data for cloud consumers of the geographic region of the distributed cloud computing service. The cloud service demand forecast may comprise a plurality of projections of cloud service usage (e.g., in virtual cores) for the geographic region and for the plurality of days or months beginning at the date defined by the temporal constraint. In some examples, the cloud service demand forecast may be augmented based on forelog and/or backlog data for one or more customers hosted by the service region.

A cloud service capacity forecast for the geographic region and a plurality of days or moths (e.g., a horizon) beginning at the date defined by the temporal constraint may be generated based on the application of the predictive simulation model to the cloud service supply variable for the geographic region. The cloud service capacity forecast may comprise a plurality of projections of cloud service capacity (e.g., in virtual cores) for the geographic region and for the plurality of days or months beginning at the date defined by the temporal constraint.

From operation 606 flow continues to operation 608 where a confidence score corresponding to a likelihood that the first service level guarantee will be met for the first organization for a threshold period of time after the date when the request is expected to be fulfilled is calculated based on the application of the predictive simulation model. The threshold period of time may correspond to the plurality of days or months beginning at the date defined by the temporal constraint. That is, the threshold period of time may correspond to the horizon that is encompassed in both the cloud service capacity forecast and the cloud service demand forecast described above. The confidence score may be determined by determining the daily capacity-demand gap (e.g., the gap distribution) for each day in the forecasts based on comparing or subtracting the cloud computing units (e.g., virtual cores) for each projection and day of the cloud service demand forecast with/from the cloud computing units (e.g., virtual cores) for each projection and day of the cloud service capacity forecast. In some examples, the confidence score may correspond to a percentage of the projections that have positive capacity (e.g., positive gap distribution). In other examples, the confidence score may correspond to a percentage of days that are determined to have more positive capacity projections than negative capacity projections.

From operation 608 flow moves to an end operation and the method 600 ends.

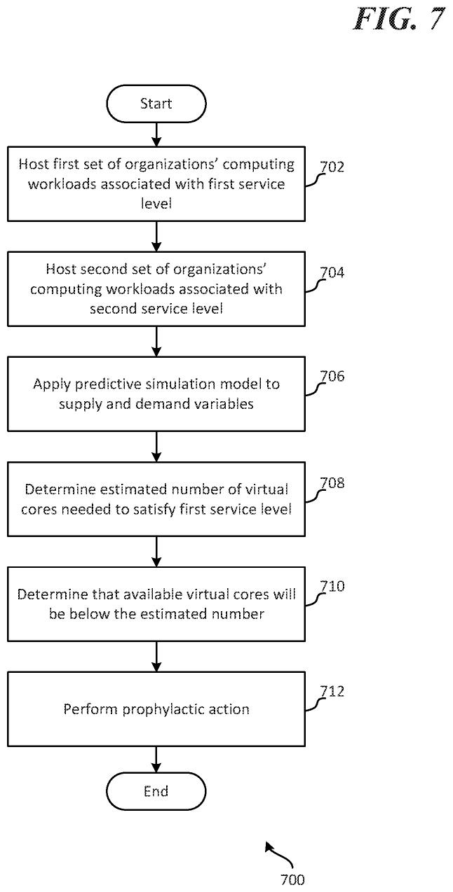

FIG. 7 is another exemplary method 700 for forecasting cloud service capacity and demand The method 700 begins at a start operation and flow moves to operation 702.

At operation 702 a first set of organizations' workloads are hosted by a distributed cloud computing service, wherein the first set of organizations are associated with a first service level. The first service level may be associated with a first confidence score for guaranteeing cloud computing resources in a geographic region of the cloud service.

From operation 702 flow continues to operation 704 where a second set of organizations' computing workloads are hosted by the distributed cloud computing service, wherein the second set of organizations are associated with a second service level that is lower than the first service level. The second service level may be associated with a second confidence score for guaranteeing cloud computing resources in a geographic region of the cloud service.

From operation 704 flow continues to operation 706 where a predictive simulation model is applied to a first plurality of cloud service demand variables for the first set of organizations, a second plurality of cloud service demand variables for the second set of organizations, and a cloud service supply variable for the geographic region of the distributed cloud computing service. The predictive simulation model may comprise a Monte Carlo model.

The first plurality of cloud service demand variables for the first set of organizations may comprise a number of forelogged virtual cores that have been requested by each organization of the first set of organizations, a number of backlogged virtual cores that have been requested by each organization of the first set of organizations, and/or virtual core usage history for each organization of the first set of organizations. The second plurality of cloud service demand variables for the second set of organizations may comprise virtual core usage history for each organization of the first set of organizations. The cloud service supply variable for the geographic region of the distributed cloud computing service may comprise a number of virtual cores that are expected to be operational at the geographic region of the distributed cloud computing service on one or more dates included in a future date range of capacity and demand forecasts that the predictive simulation model is utilized to generate.

From operation 706 flow continues to operation 708 where a determination is made, based on application of the predictive simulation model, as to an estimated number of virtual cores needed to satisfy the first service level for a first organization of the first set of organizations for a future period of time. The determination may be made based on determining daily capacity-demand gaps (e.g., gap distributions) for a plurality of projections of the capacity and demand forecasts that the predictive simulation model is utilized to generate.

From operation 708 flow continues to operation 710 where a determination is made, based on application of the predictive simulation model, that an estimated number of available virtual cores during the future period of time will be below the estimated number of virtual cores needed to satisfy the first service level for the first organization. For example, a confidence score calculated based on the percentage of projections, in the future period of time, that had a positive supply/capacity gap from the capacity and demand forecasts may fall below a confidence score threshold associated with the first service level.

From operation 710 flow continues to operation 712 where a prophylactic action to provide additional virtual cores to satisfy the first service level for the first organization is performed. The prophylactic action may comprise placing a hold on fulfilling a backlog request for the geographic region of the distributed cloud computing service for an organization with a second service level guarantee that is lower than the first service level guarantee. In other examples, the prophylactic action may comprise moving computing workloads from one or more customers to a different service region of the distributed cloud computing service.

From operation 712 flow moves to an end operation and the method 700 ends.

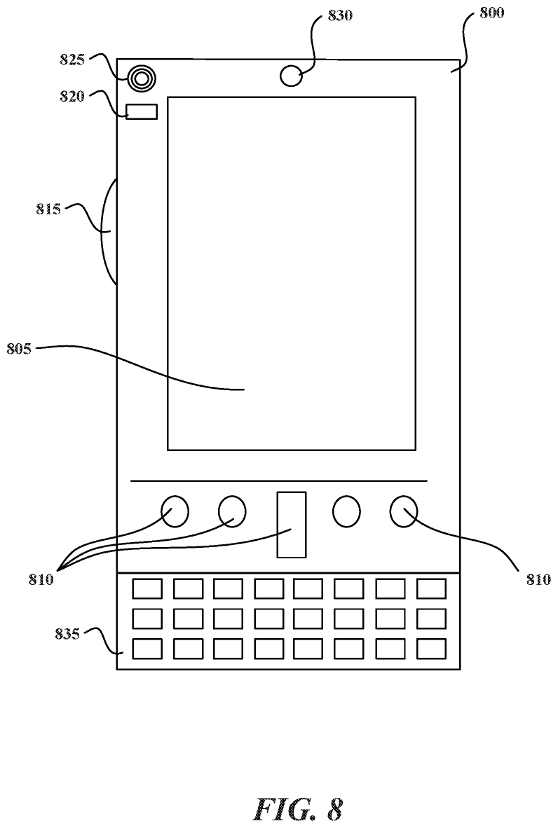

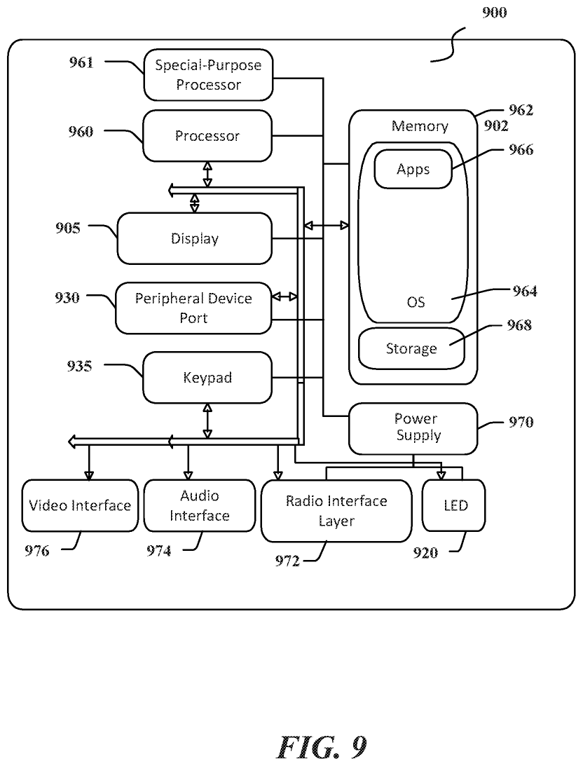

FIGS. 8 and 9 illustrate a mobile computing device 800, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 8, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or fewer input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 9 is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900, including instructions for providing and operating a cloud forecast application.

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 820 may be used to provide visual notifications, and/or an audio interface 974 may be used for producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

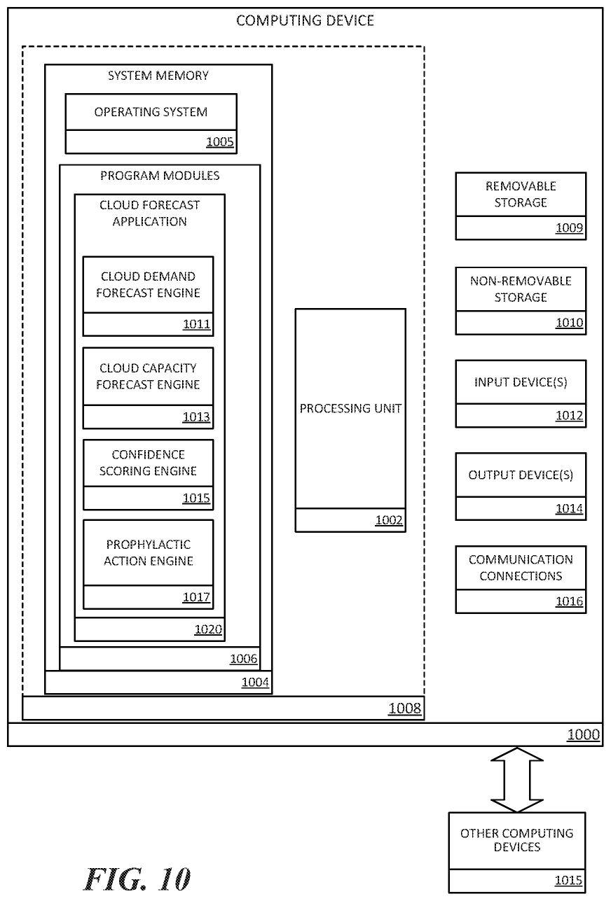

FIG. 10 is a block diagram illustrating physical components (e.g., hardware) of a computing device 1000 with which aspects of the disclosure may be practiced. The computing device components described below may have computer executable instructions for assisting with generating cloud service forecasts. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 suitable for running one or more cloud forecast applications. The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., cloud forecast application 1020) may perform processes including, but not limited to, the aspects, as described herein. According to examples, cloud demand forecast engine 1011 may perform one or more operations associated with generating a cloud demand forecast for one or more cloud service regions based on application of a predictive simulation model to a plurality of demand variables for a plurality customers/consumers associated with the one or more cloud service regions. Cloud capacity forecast engine 1013 may perform one or more operations associated with generating a cloud capacity forecast for one or more cloud service regions based on application of a predictive simulation model to at least one cloud supply variable associated with the one or more cloud service regions. Confidence scoring engine 1015 may perform one or more operations associated with generating/calculating a confidence score that cloud capacity will exceed cloud demand for one or more service regions. Prophylactic action engine 1017 may perform one or more operations associated with ensuring that cloud capacity meets cloud demand for high priority customers/consumers. The one or more operations may include placing a hold on filling backlogs or forelogs for lower priority customers/consumers and/or moving computing workloads for lower priority customers/consumers to different service regions.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer readable media and computer storage media as described herein does not include transitory media such as a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

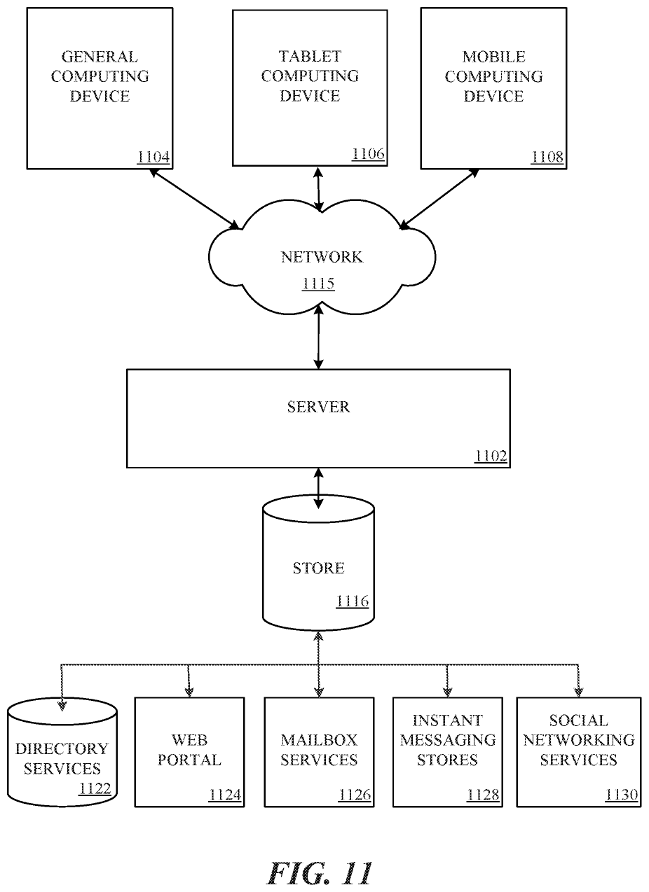

FIG. 11 illustrates one aspect of the architecture of a system for processing data received at a computing system from a remote source, such as a personal/general computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130. The program modules 1006 may be employed by a client that communicates with server device 1102, and/or the program modules 1006 may be employed by server device 1102. The server device 1102 may provide data to and from a client computing device such as a personal/general computer 1104, a tablet computing device 1106 and/or a mobile computing device 1108 (e.g., a smart phone) through a network 1115. By way of example, the computer system described above may be embodied in a personal/general computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure.

The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure. The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for forecasting cloud service capacity and demand, the computer-implemented method comprising:
receiving, from a first organization, a forecasted request for cloud computing on a distributed cloud computing service, the forecasted request comprising:
a number of virtual cores needed to fulfill the forecasted request;
a temporal constraint defining a date when the request is expected to be fulfilled; and
a geographic region of the distributed cloud computing service where the cloud computing is expected to be fulfilled;
determining a cloud computing service level of the first organization, wherein the cloud computing service level is associated with a first service level guarantee;
applying a predictive simulation model to:
a first plurality of cloud service demand variables for the first organization;
a second plurality of cloud service demand variables for a second organization that is provided service by the distributed cloud computing service in the geographic region; and
a cloud service supply variable for the geographic region of the distributed cloud computing service;
calculating, based on the application of the predictive simulation model, a confidence score corresponding to a likelihood that the first service level guarantee will be met for the first organization for a threshold period of time after the date when the request is expected to be fulfilled;
determining that the confidence score is below a threshold value corresponding to the first service level guarantee; and
performing a prophylactic action making additional virtual cores available for the first organization in the geographic region.

2. The computer-implemented method of claim 1, wherein the prophylactic action comprises reassigning a plurality of virtual cores in the geographic region from one or more other organizations hosted by the distributed cloud computing service to the first organization.

3. The computer-implemented method of claim 1, wherein the prophylactic action comprises placing a hold on fulfilling a backlog request for the geographic region of the distributed cloud computing service for an organization with a second service level guarantee that is lower than the first service level guarantee.

4. The computer-implemented method of claim 1, further comprising:
generating, based on application of the predictive simulation model to the first plurality of cloud service demand variables and the second plurality of cloud service demand variables, a plurality of demand forecasts for the geographic region of the distributed cloud computing service and the threshold period of time; and
generating, based on application of the predictive simulation model to the cloud service supply variable, a plurality of supply forecasts for the geographic region of the distributed cloud computing service and the threshold period of time.

5. The computer-implemented method of claim 1, further comprising:
determining, based on the application of the predictive simulation model, a daily estimate of virtual core use for the geographic region of the distributed cloud computing service for each day from a current day until the date when the request is expected to be fulfilled.

6. The computer-implemented method of claim 1, wherein the first plurality of cloud service demand variables comprise:
the number of virtual cores included in the request;
virtual core usage history of the first organization for the geographic region of the distributed cloud computing service for a plurality of past days; and
a number of virtual cores backlogged for the first organization for the geographic region of the distributed cloud computing service.

7. The computer-implemented method of claim 1, wherein the second plurality of cloud service demand variables comprise:
virtual core usage history for the second organization for the geographic region of the distributed cloud computing service for a plurality of past days;
a number of virtual cores backlogged for the second organization for the geographic region of the distributed cloud computing service; and
a number of virtual cores forelogged for the second organization for the geographic region of the distributed cloud computing service.

8. The computer-implemented method of claim 1, wherein the cloud service supply variable for the geographic region of the distributed cloud computing service comprises:
a number of virtual cores that are expected to be operational at the geographic region of the distributed cloud computing service on the date when the request is expected to be fulfilled.

9. The computer-implemented method of claim 1, wherein the predictive simulation model is a Monte Carlo model.

10. A system for forecasting cloud service capacity and demand, comprising:
a memory for storing executable program code; and
a processor, functionally coupled to the memory, the processor being responsive to computer-executable instructions contained in the program code and operative to:
host a first set of organizations' computing workloads by a distributed cloud computing service, wherein the first set of organizations are associated with a first service level;
host a second set of organizations' computing workloads by the distributed cloud computing service, wherein the second set of organizations are associated with a second service level that is lower than the first service level;
apply a predictive simulation model to:
a first plurality of cloud service demand variables for the first set of organizations;
a second plurality of cloud service demand variables for the second set of organizations; and
a cloud service supply variable for the geographic region of the distributed cloud computing service;
determine, based on application of the predictive simulation model, an estimated number of virtual cores needed to satisfy the first service level for a first organization of the first set of organizations for a future period of time;
determine, based on application of the predictive simulation model, that an estimated number of available virtual cores during the future period of time will be below the estimated number of virtual cores needed to satisfy the first service level for the first organization; and
perform a prophylactic action to provide additional virtual cores to satisfy the first service level for the first organization.

11. The system of claim 10, wherein the predictive simulation model is a Monte Carlo model.

12. The system of claim 10, wherein the first plurality of cloud service demand variables for the first set of organizations comprise:
a number of forelogged virtual cores that have been requested by each organization of the first set of organizations;
a number of backlogged virtual cores that have been requested by each organization of the first set of organizations; and
virtual core usage history for each organization of the first set of organizations.

13. The system of claim 10, wherein the second plurality of cloud service demand variables for the second set of organizations comprise:
virtual core usage history for each organization of the first set of organizations.

14. A computer-readable storage device comprising executable instructions that, when executed by a processor, assists with forecasting cloud service capacity and demand, the computer-readable storage device including instructions executable by the processor for:
receiving, from a first organization, a forecasted request for cloud computing on a distributed cloud computing service;
determining, from the forecasted request:
a number of virtual cores needed to fulfill the forecasted request;
a temporal constraint defining a date when the request is expected to be fulfilled; and
a geographic region of the distributed cloud computing service where the cloud computing is expected to be fulfilled;
determining a cloud computing service level of the first organization, wherein the cloud computing service level is associate with a first service level guarantee;
applying a predictive simulation model to:
a first plurality of cloud service demand variables for the first organization;
a second plurality of cloud service demand variables for a plurality of additional organizations that are provided service by the geographic region of the distributed cloud computing service; and
a cloud service supply variable for the geographic region of the distributed cloud computing service;
calculating, based on the application of the predictive simulation model, a confidence score corresponding to a likelihood that the first service level guarantee will be met for the first organization for a threshold period of time after the date when the request is expected to be fulfilled;
determining that the confidence score is below a threshold value corresponding to the first service level guarantee; and
performing a prophylactic action making additional virtual cores available for the first organization in the geographic region.

15. The computer-readable storage device of claim 14, wherein the prophylactic action comprises reassigning a plurality of virtual cores in the geographic region from one or more other organizations hosted by the distributed cloud computing service to the first organization.

16. The computer-readable storage device of claim 14, wherein the prophylactic action comprises placing a hold on fulfilling a backlog request for the geographic region of the distributed cloud computing service for an organization with a second service level guarantee that is lower than the first service level guarantee.

17. The computer-readable storage device of claim 14, wherein the instructions are further executable by the processor for:
determining, based on the application of the predictive simulation model, a daily estimate of virtual core use for the geographic region of the distributed cloud computing service for each day from a current day until the date when the request is expected to be fulfilled.

18. The computer-readable storage device of claim 14, wherein the first plurality of cloud service demand variables comprise:
the number of virtual cores needed to fulfill the forecasted request;
virtual core usage history of the first organization for the geographic region of the distributed cloud computing service for a plurality of past days; and
a number of virtual cores backlogged for the first organization for the geographic region of the distributed cloud computing service.

19. The computer-readable storage device of claim 14, wherein the second plurality of cloud demand variables comprise:
virtual core usage history for each of the plurality of additional organizations for the geographic region of the distributed cloud computing service for a plurality of past days;
a number of virtual cores backlogged for each of the plurality of additional organizations for the geographic region of the distributed cloud computing service; and
a number of virtual cores forelogged for each of the plurality of additional organizations for the geographic region of the distributed cloud computing service.

20. The computer-readable storage device of claim 14, wherein the cloud service supply variable for the geographic region of the distributed cloud computing service comprises:
a number of virtual cores that are expected to be operational at the geographic region of the distributed cloud computing service on the date when the request is expected to be fulfilled.
